(19) United States
(12) Patent Application Publication
(10) Pub. No.: US 2023/0031458 A1
(43) Pub. Date: Feb. 2, 2023

(54) METHOD AND APPARATUS FOR ASSISTING USER IN VEHICLE WITH AT LEAST ONE RADIO STATION

(71) Applicant: MERCEDES-BENZ GROUP AG, Stuttgart (DE)

(72) Inventors: Ting-Wei HSU, Mountain View, CA (US); Sachin ATHANIKAR, Cupertino, CA (US)

(21) Appl. No.: 17/785,992

(22) PCT Filed: Oct. 20, 2020
(86) PCT No.: PCT/EP2020/079522

§ 371 Date: Jun. 16, 2022

(30) Foreign Application Priority Data
Dec. 17, 2019 (IN) 201941052435

(51) Int. Cl. H04H 60/46; H04H 60/51; H04H 60/53; H04H 60/42

(52) U.S. Cl. CPC H04H 60/46; H04H 60/51; H04H 60/53; H04H 60/42

(57) ABSTRACT

In order to assist a user in a vehicle with at least one radio station, at least one preference of the user is determined using preferences of pre-stored clusters of plurality of users. Each of the pre-stored clusters includes users with similar preferences related with listening to radio stations. Further, at least one radio station from one or more potential radio stations available for the user is selected based on the at least one preference. The at least one radio station is assisted to the user in the vehicle.

### DESCRIPTION OF THE INVENTION

### Technical Field

The present subject matter is related in general to vehicle systems, more particularly, but not exclusively to method and apparatus for assisting user in vehicle with at least one radio station.

### Background

Generally, vehicle includes various subsystems. One of the subsystems in vehicle include an infotainment system designed to receive signals from radio stations available within proximity of the vehicle. The user in the vehicle is able to tune into radio station which may play preferred content. When traveling in the vehicle, availability of the radio stations to tune-in, may vary based on route/location of the vehicle currently traveling and signal coverage of the radio stations in the route/location. The user needs to be in control of searching for a radio station that plays contents as per their preferences, and available for the vehicle. In circumstances where radio stations are not available for the location of the vehicle, the user may have to manually tune to the radio stations. Such manual tuning is normally very time consuming and a distraction to user, which may lead to safety issues and a detriment to experience of the user.

Some of existing systems disclose implementing an auto-store or -tuning mechanism in the infotainment system, to select radio stations that are available within the location of the vehicle. Such systems may be configured to randomly pick a radio station or to select a radio station with the nearest strongest signals for the user, without considering preferences of the user. Some other existing systems disclose radio station searching mechanisms where the radio stations are searched using a profile of the user. The profile may include behavior of the user and listening habits of the user in relation with an available radio station. However, such systems may provide a recommendation restricted to the profile of the user. If any of the available radio stations fail to be associated with the profile, such systems may fail to provide a recommendation of a radio station to the user. Also, such cases may require the user to manually operate the infotainment system to tune into a radio station or to provide new set of preferences for initiating the auto-storing in the infotainment system.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE DISCLOSURE

In an embodiment, the present disclosure relates to a method for assisting a user in a vehicle with at least one radio station. Assisting incorporates for example identifying and/or recommending a user with at least one radio station. For assisting, at least one preference of a user in a vehicle is determined using preferences of pre-stored clusters of plurality of users. Each of the pre-stored clusters comprises users with similar preferences related with listening to radio stations. Further, at least one radio station from one or more potential radio stations available for the user is selected based on the at least one preference. The at least one radio station is assisted to the user in the vehicle.

In an embodiment, the present disclosure relates to an apparatus for assisting a user in a vehicle with at least one radio station. The apparatus comprises a processor and a memory communicatively coupled to the processor. The memory stores processor-executable instructions, which, on execution, cause the processor to assist the at least one radio station. Initially, at least one preference of a user in a vehicle is determined using preferences of pre-stored clusters of plurality of users. Each of the pre-stored clusters comprises users with similar preferences related with listening to radio stations. Further, at least one radio station from one or more potential radio stations available for the user is selected based on the at least one preference. The at least one radio station is assisted to the user in the vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows exemplary environment 100 of an apparatus for assisting in the sense of identifying and/or recommending a user in a vehicle with at least one radio station, in accordance with some embodiments of the present disclosure;

FIG. 2 shows a detailed block diagram of an apparatus for assisting a user in a vehicle with at least one radio station, in accordance with some embodiments of the present disclosure;

FIGS. 3a-3f show exemplary embodiments for assisting a user in a vehicle with at least one radio station, in accordance with some embodiments of the present disclosure;

FIG. 4a shows a flow diagram illustrating method for assisting a user in a vehicle with at least one radio station, in accordance with some embodiments of present disclosure;

FIG. 4b shows a flow diagram illustrating method for identifying one or more potential radio stations available for a user, in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure discloses an apparatus and method for assisting a user in a vehicle with at least one radio station. The at least one radio station is recommended to the user based on preferences of the user which is derived in comparison with user associated with similar preferences. Based on such preferences of the user, available radio stations in surroundings of the vehicle is considered and best recommendation is provided to the user. The present disclosure discloses a model utilizing profiles of multiple users for improving prediction and learning of the user preferences and recommending best matched radio station.

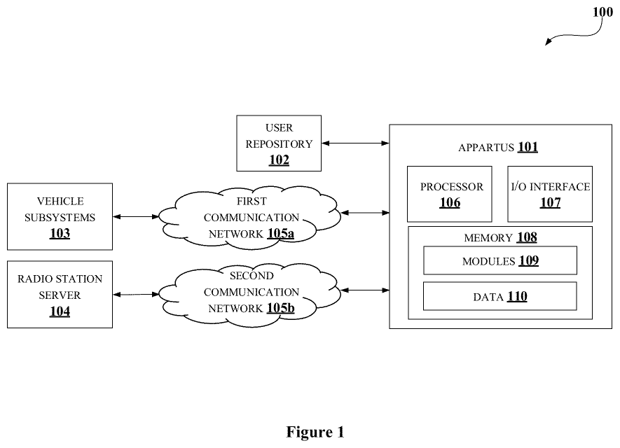

FIG. 1 shows an exemplary environment 100 associated with an apparatus 101 for assisting user in a vehicle with at least one radio station. The apparatus 101 may be in communication with a user repository 102, vehicle subsystems 103, and a radio station server 104. In an embodiment, the apparatus 101 may be a dedicated server or a cloud-based server in communication with the at least one of the user repository 102, the vehicle subsystems 103, and the radio station server 104. In an embodiment, the apparatus 101 may be implemented in a variety of computing systems, such as a laptop computer, a desktop computer, a Personal Computer (PC), a notebook, a smartphone, a tablet, e-book readers, a server, a network server, and the like. The apparatus 101 may communicate with the vehicle subsystems 103 via a first communication network 105a and with the radio station server 104 via a second communication network 105b. Each of the first communication network 105a and the second communication network 105b may include, but is not limited to, at least one of a direct interconnection, a Peer to Peer (P2P) network, Local Area Network (LAN), Wide Area Network (WAN), wireless network (e.g., using Wireless Application Protocol), Controller Area Network (CAN), the Internet, Wi-Fi, and such. In an embodiment, the apparatus 101 may communicate with the user repository 102 via a dedicated communication network or one of the first communication network 105a and the second communication network 105b. In an embodiment, the environment 100 may include a single communication network to establish communication between the apparatus 101 and the user repository 102, the vehicle subsystems 103 and the radio station server 104.

The vehicle may be considered to be a system with several subsystems which together may be referred to as the vehicle subsystems 103. The vehicle subsystems 103 may include, but is not limited to, braking system, navigation system, GPS system, I/O system, infotainment system, fuel system, security system, and so on. Each of the vehicle subsystems 103 may be configured to perform corresponding functions for proper functioning of the vehicle. For example, the braking system may deal with braking of the vehicle. The I/O system may comprise multiple input and output modules to receive and output certain data for user in the vehicle. The infotainment system may be configured to play music, videos and entertain the user. The navigation system may aid in providing navigation to the vehicle to reach a destination. The GPS system may be configured to track current location of the vehicle. The apparatus 101 may be in communication with some of such vehicle subsystems 103 to provide service of assisting the user with the at least one radio station. In an embodiment, the apparatus 101 may be in communication with the I/O system, the navigation system, the GPS system, and the infotainment system. In an embodiment, the apparatus 101 along with the vehicle subsystems 103 may be integral part of the vehicle.

The radio station server 104 may be a third-party server associated with plurality of radio stations in geographical location of the vehicle. The radio-station server may store relevant data associated with the plurality of radio stations. In an embodiment, the relevant data may include, but is not limited to, signal coverage area, frequency data, metadata, and so on associated with each of the plurality of radio stations. The signal coverage data of a radio station may include information related to coverage area of the radio station and signal strength of the radio station at a particular location. The frequency data of a radio station may include tuning frequency associated with the radio station. The metadata of a radio station may include genres, playlists, artists, and so on, related to contents played by the radio station. In an embodiment, the radio station server 104 may be in communication with the infotainment system (not shown in Figure), for entertaining the user in the vehicle using the plurality of radio stations. The apparatus 101 is in communication with the radio station server 104 to receive the relevant data which may be used for assisting the user with at least one radio station, based on preference of the user.

The user repository 102 may be centralized database or cloud-based database configured to store data associated with plurality of users. The plurality of users may be users who may regularly listen to radio stations in vehicle. For a particular user, the user repository 102 may store data including user information inputted by the user and historic data associated with radio stations listened by the user. The user information inputted by the user may include preferred radio station of the user, favorite song, artist genre and so on associated with the user. Such data may be stored for each of the plurality of users in the user repository 102. The apparatus 101 may be configured to receive required data from the user repository 102, for assisting a user in a vehicle with best matched radio station.

The apparatus 101 comprises a processor 106 and a memory 108 communicatively coupled to the processor 106. The memory 108 stores processor-executable instructions, which, on execution, cause the processor 106 to assist the at least one radio station to the user. For assisting the user in the vehicle with the at least one radio station, at real-time, the apparatus 101 may be configured to determine at least one preference of the user in the vehicle, using preferences of pre-stored clusters of the plurality of users. In an embodiment, each of the pre-stored clusters may comprise users with similar preferences related with listening to radio stations. Each of the pre-stored clusters may include set of users and corresponding preferences of said set of users.

In an embodiment, the apparatus 101 may be configured to generate the pre-stored clusters of the plurality of users. The generation of the pre-stored clusters may be performed during deployment of the apparatus 101 with the vehicle. In an embodiment, the apparatus 101 may be configured to generate the pre-stored clusters when a request from new user is received for assistance of a radio station. In an embodiment, the apparatus 101 may be configured to re-generate/update the pre-stored clusters, dynamically, when a change in preferences of a user from the plurality of users is detected. The apparatus 101 may be configured to generate the pre-stored clusters based on at least one of the user information provided by each of the plurality of users and/or the historic data associated with radio stations listened by each of the plurality of users. The user information and the historic data may be received from the user repository 102. In an embodiment, the pre-stored clusters generated for the plurality of users may be stored in the user repository 102.

The apparatus 101 is configured to determine the at least one preference of the user by identifying a cluster from the pre-stored clusters, which is associated with users similar to the user in the vehicle. The similarity between the users in the cluster and the user in the vehicle is based on at least one of user information provided by the users and/or historic data associated with radio stations listened by the users. Further, the at least one preference associated with one or more users in the identified cluster is determined to be associated with the user in the vehicle.

Upon determining the at least one preference, the apparatus 101 may be configured to select the at least one radio station from one or more potential radio stations available for the user. The at least one radio station is selected based on the at least one preference.

In an embodiment, the apparatus 101 may be configured to identify the one or more potential radio stations to perform the selection of the at least one radio station. The apparatus 101 may be configured to perform the identification of the one or more potential radio stations, in real-time, for assisting the user with the at least one radio station. For identifying the one or more potential radio stations, the apparatus 101 may be configured to determine at least one of a route and a current location of the vehicle. In an embodiment, the route and the current location may be determined using the navigation system or the GPS system, respectively. Further, the apparatus 101 may receive signal coverage data related to plurality of radio stations available within at least one of the route and the current location of the vehicle. In an embodiment, the signal coverage data may be received from the radio station server 104. Signal strength is derived from corresponding signal coverage data of each of the plurality of radio stations and compared with a predefined threshold value. Signal strength of each of the plurality of radio stations is compared with the predefined threshold value. If the signal strength of a radio station, from the plurality of radio stations, is less than the predefined threshold value, the radio station, whose signal strength is less than the predefined threshold value, is determined to be non-potential radio station for the user. If the signal strength of a radio station is greater than the predefined threshold value, the radio station, whose signal strength is greater than the predefined threshold value, is determined to be one of the one or more potential radio stations. Likewise, a list of all the potential radio stations is determined by the apparatus 101 and the at least one radio station is selected from the list of all the potential radio stations.

Further using the list of the one or more potential radio stations, the apparatus 101 is configured to select the at least one radio station by receiving the metadata associated with the one or more potential radio stations. The metadata may be received by the apparatus 101 from the radio station server 104, in real-time. Using the received metadata for the one or more potential radio stations, the apparatus 101 may be configured to categorize the at least one preference of the user to be related to a metadata associated with at least one radio station from the one or more potential radio stations. The at least one radio station is used for providing assistance to the user.

Upon selecting the at least one radio station, the apparatus 101 may be configured to assist the user with the at least one radio station in the vehicle. In an embodiment, the assistance may be provided by recommending to the user at least one radio station using the infotainment system in the vehicle. In an embodiment, the assistance of the at least one radio station may be provided by auto-tuning the infotainment system in the vehicle to the at least one radio station.

In an embodiment, the apparatus 101 may be associated with plurality of vehicles and users, to assist the users with corresponding radio station based on respective preference. In an embodiment, the apparatus 101 may be associated with a plurality of infotainment systems of the plurality of vehicles, for assisting the at least one radio station. In an embodiment, the apparatus 101 may communicate with each of plurality of infotainment systems, via dedicated communication network. The I/O interface 107 of the apparatus 101 may be configured to provision transmission and reception of data. Received data may include, but is not limited to, the user information, the historic data, the pre-stored clusters, the signal coverage data, the route, the current location, and so on. Transmitted data may include, but is not limited to, generated pre-stored clusters, determined preference, selected radio station, and so on. One or more other data, which is related to assisting the user in the vehicle with the at least one radio station, may be received and transmitted via the I/O interface 107.

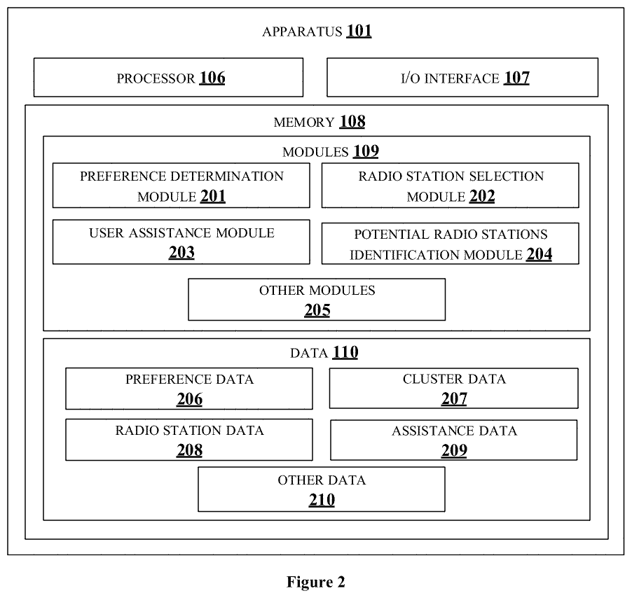

FIG. 2 shows a detailed block diagram of the apparatus 101 for assisting i.e., identifying and recommending a user with the at least one radio station, in accordance with some embodiments of the present disclosure.

The data 110 and the one or more modules 109 in the memory 108 of the apparatus 101 described herein in detail.

In one implementation, the one or more modules 109 may include, but are not limited to, a preference determination module 201, a radio station selection module 202, a user assistance module 203, a potential radio stations identification module 204, and one or more other modules 205 associated with the apparatus 101.

In an embodiment, the data 110 in the memory 108 may include preference data 206 (also referred to as at least one preference 206), cluster data 207 (also referred to as pre-stored clusters 207), radio station data 208, assistance data 209, and other data 210 associated with the apparatus 101.

In an embodiment, the data 110 in the memory 108 may be processed by the one or more modules 109 of the apparatus 101. In an embodiment, the one or more modules 109 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

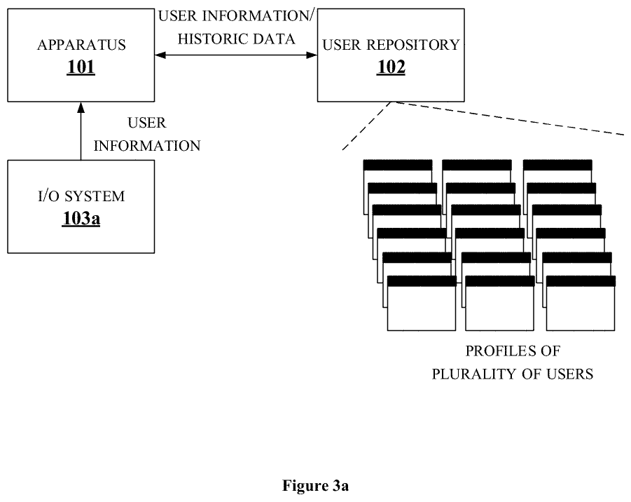

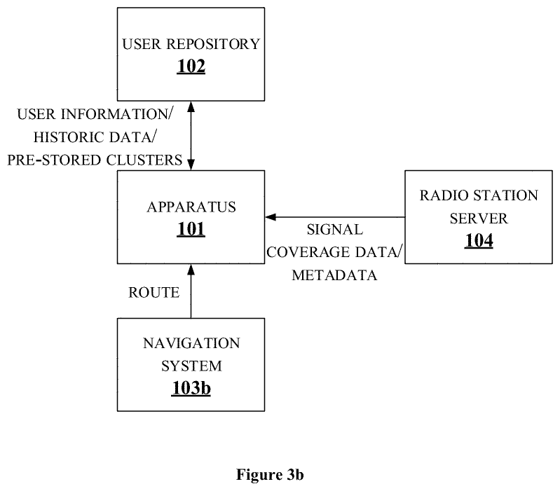

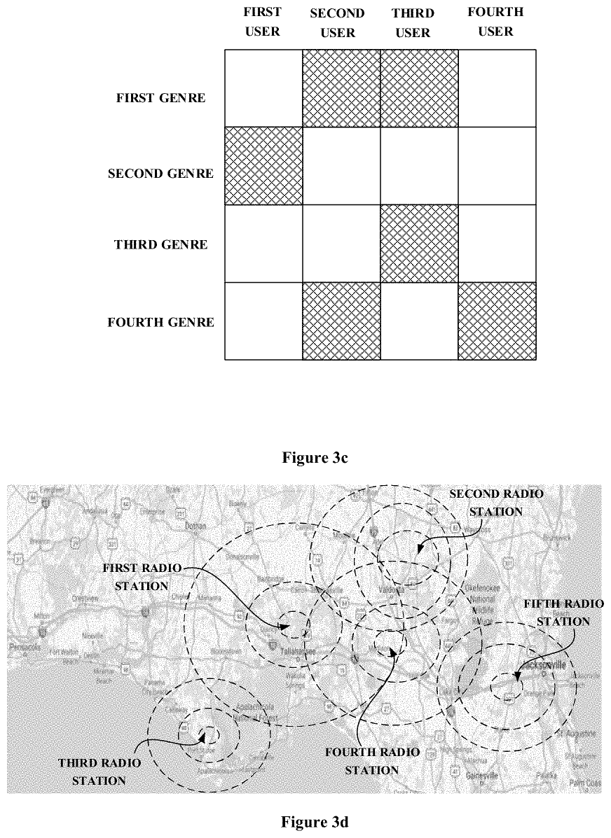

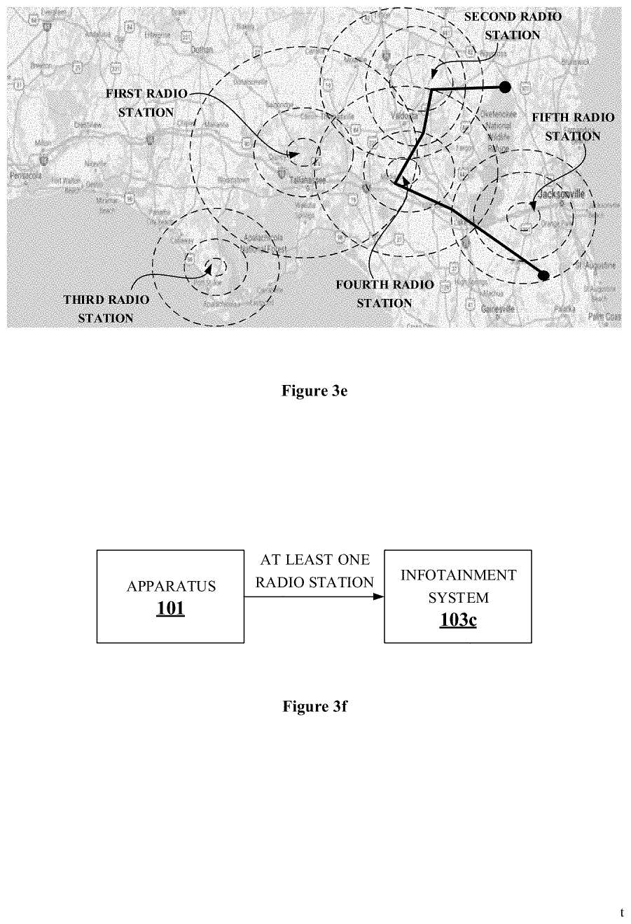

The proposed apparatus 101 aims to automatically suggest new radio stations which are not previously listened by a user based on behaviors and preferences of the user. Initially, when a user is new to seek experience of the assistance provided by the apparatus 101, the one or more other modules 205 of the apparatus 101 may be configured to receive user information of the user in order to set-up a profile of the user with the apparatus 101. The user information may include user inputted preferences including, but is not limited to, preferred radio station, favorite song, artist, genre, ad-less radio station, preferred language, and so on. In an embodiment, the apparatus 101 may receive the user information via the I/O system 103a of the vehicle as shown in FIG. 3a. Also, the one or more other modules 205 may be configured to track listening pattern of the user over a period of time. Such data including listening pattern, may be stored and updated as historic data of the user, in the profile of the user. Such profile may be set-up for plurality of users seeking service of the apparatus 101. Each of the profiles of the plurality of users may be communicated and stored in the user repository 102, as shown in FIG. 3a. In an embodiment, the apparatus 101 may be configured to retrieve the profiles, in real-time, from the user repository 102, for assisting a user with a radio station. In an embodiment, one or more techniques, known to a person skilled in the art, may be implemented to set-up profiles for the plurality of users.

Along with the profile for the plurality of users, the one or more other modules 205 of the apparatus 101 may be configured to generate the pre-stored clusters 207 for the plurality of users. Each cluster from the pre-stored clusters 207 may include a set of users with similar preferences and similar historic data. The generation of the pre-stored clusters 207 may be performed when setting-up profiles for the users. In an embodiment, the generation of the pre-stored clusters 207 may be performed in real-time, when a need for assisting a radio station for a user arises. In an embodiment, the one or more other modules 205 may be configured to update the pre-stored clusters 207 based on change in preferences of the plurality of users and recommendations provided to the plurality of users. One or more clustering techniques, known to a person skilled in art, may be implemented to generate the pre-stored clusters 207 of the plurality of users.

In real-time, in an embodiment, for initiating the apparatus, a user in a vehicle may initially send a request to the apparatus 101, for seeking service of the apparatus 101. In an embodiment, the request may be directly sent to the apparatus 101 via the vehicle subsystems 103 of the vehicle. For example, the user may initiate the apparatus 101 by providing a voice command or by selecting a suitable option in the infotainment system 103c. In such case, the voice command or the selected option may be communicated as the request for seeking the service of the apparatus. The apparatus may be initiated above received such from the user. In another embodiment, the apparatus 101 may be in communication with the navigation system 103b to initiate the service, as shown in FIG. 3b. For example, when the user in the vehicle inputs a destination location, the navigation system 103b may generate an optimal route to reach the destination and communicate the route to the apparatus 101. Upon receipt of the route, the apparatus 101 may be initiated to assist the at least one radio station to the user. In an embodiment, the apparatus 101 may be in communication with the GPS system (not shown in the Figure) to initiate the service. As soon as the vehicle starts to transit, a current location of the vehicle may be communicated by the GPS system to the apparatus 101, to initiate the apparatus 101. One or more other mechanisms, known to a person skilled in the art, may be implemented to initiate the apparatus 101.

In an embodiment, the one or more other modules 205 of the apparatus 101 may be implemented to directly communicate with the user to receive the destination location or the current location and initiate the service of assisting the user with the at least one radio station. In an embodiment, the one or more other modules 205 may include a predictive model to predict the destination location based on various parameters and initiate the service, automatically. For example, at morning 9 am, when a user is in the vehicle and starts the vehicle, the one or more other modules 205 may predict the destination location to be work place of the user and accordingly provide service to the user, until the user reaches the destination location. In an embodiment, the one or more other modules 205 may track number of times of re-routing of the vehicle i.e., the user detoured the route and did not follow the entered route. Such information may be learned by the predictive model and used for providing service for next tour of the user. Such predictive model helps in enhancing and automating the service provided by the apparatus 101 to the user.

Upon initiating the apparatus 101, the preference determination module 201 may be configured to determine at least one preference 206 of the user in the vehicle, using preferences of the pre-stored clusters 207 of the plurality of users. Each of the pre-stored cluster may be associated with one or more common preferences amongst the user in the respective cluster. For example, consider the below table 1 with list of users and exemplary preferences.

TABLE 1

| | | | | Historic data |
|---|---|---|---|---|
| | | | | (most listened |
| User | Song | Genre | Artist | radio station) |
| First user | Song A | Genre M | Artist X | First radio station |
| Second user | Song C | Genre M | Artist Y | Second radio |
| | | | | station |
| Third user | Song B | Genre M | Artist Y | First radio station |
| Fourth user | Song A | Genre N | Artist Y | First radio station |
| Fifth user | Song A | Genre N | Artist X | Third radio station |
| Sixth user | Song A | Genre M | Artist X | First radio station |

Based on above user profile, preferences of the first user and the sixth user are identified as similar. Hence, a cluster may be generated comprising the first user and the sixth user, with preference for the cluster to be Song A, Genre M, Artist X and first radio station. Similarly, rest of the users may be clustered, and each cluster may be associated with corresponding preference.

The preference determination module 201 may be configured to consider the user information and the historic data provided by the user to identify other users similar to the user in the vehicle. For example, consider user information received from the user in the vehicle is Song B and Artist Y. From the pre-stored clusters 207, it may be identified that preferences of third user is similar to that of the user in the vehicle. Hence, the cluster associated with the third user is identified to be the cluster associated with the user in the vehicle. The preferences of the cluster of the third user is Song B, Genre M, Artist Y and first radio station. Hence, the at least one preference 206 for the user in the vehicle may be determined to be Genre M and first radio station, along with provided preferences of Song B and Artist Y.

Similarly, consider a plot provided in FIG. 3c, indicating preferences of genre of songs of a first user, a second user, a third user and a fourth user. Consider the fourth user is the user in the vehicle whose preferences is to be determined. The user information indicates the fourth user prefers listening to fourth genre of songs. From the plot, the preference determination module 201 may identify that even the second user prefers listening to the fourth genre of songs. Also, it may be identified that the second user also listens to first genre of songs. Hence, the at least one preference 206 determined for the fourth user may include the fourth genre of songs (as provided by the fourth user) and the first genre of songs which is determined based on similarity. Consider the user in the vehicle is the first user who prefers listening to second genre of songs. Since no other user is associated with preference similar to that of the first user, the at least one preference 206 determined for the first user may be the second genre of songs only. However, in real-life scenario, several users are involved for determining the at least one preference 206 and similar users are identified for every user.

In an embodiment, the preference determination module 201 may be configured to match the user information and the historic data of the user in the vehicle with the user information and the historic data of other users, using methods known to a person skilled in the art. By such matching, exhaustive list of preferences for the user may be determined with minimal information from the user.

Upon determining the at least one preference 206, the radio station selection module 202 may be configured to select the at least one radio station from the one or more potential radio stations available for the user. In an embodiment, before selecting the at least one radio station, the potential radio stations identification module 204 may be configured to identify the one or more potential radio stations for the route or the current location of the vehicle. Once the route/current location is identified for the vehicle, the potential radio stations identification module 204 may be configured to map signal coverage data of the plurality of the radio stations in the geographical location of the vehicle with the route and the current location. In an embodiment, the signal coverage data may be received from the radio station server 104, in real-time, as shown in FIG. 3b. In an embodiment, the radio station server 104 may be configured to provide information including, but is not limited to, tuning frequency, latitude & longitude of the coverage, center of the transmitter point and radius, and so on, for the mapping. The received data from the radio station server 104 may be stored as the radio station data 208 in the memory 108. Upon receiving the information from the radio station server 104, the potential radio stations identification module 204 may be configured to derive signal strength of each of the plurality of radio station, based on the route or the current location of the vehicle. FIG. 3d shows a simplified visual representation of mapping signal strength of the plurality of radio stations in the geographical location of the vehicle. Consider the plurality of radio stations include first radio station, second radio station, third radio station, fourth radio station, and fifth radio station. The signal strength of each of the plurality of radio stations is represented as circles, where inner circle coverage area represents stronger signal strength and outer circle coverage area represents minimal signal strength. As shown in FIG. 3d, in real life scenario, there may be a multiple different radio stations overlapping in same zone.

In an embodiment, the potential radio stations identification module 204 uses the signal strength of the plurality of radio stations to convert the route or the current location into latitude and longitude points of the vehicle. The potential radio stations identification module 204 may be in communication with the navigation system to receive the route and with the GPS system to receive the current location. Further, the potential radio stations identification module 204 checks for an overlap between the latitude and the longitude points of the vehicle with latitude and longitude points of the plurality of radio stations. When the overlap is identified with a particular radio station from the plurality of radio stations, such radio station may be considered to be one of the one or more potential radio stations. In an embodiment, the potential radio stations identification module 204 may be configured to filter out the radio stations that may be identified to lose signal in certain threshold of time, along the route of the vehicle. For example, consider the route determined for the user, as shown in FIG. 3e. Based on the latitude and the longitude points, the one or more potential radio stations for the user may be identified to be the second radio station, the fourth radio station, the fourth radio station, and the fifth radio station. It may be identified that the first radio station may be good for a very short period of time, along the route of the vehicle. It may not be optimal to assist the user with the first radio station in the route. Hence, the potential radio stations identification module 204 may be configured to filter out the first radio station and remove as one of the one or more potential radio stations.

Further, the potential radio stations identification module 204 may be configured to compare the signal strength of each of the plurality of radio stations or radio stations which are identified using latitude and longitude points, with the predefined threshold value. If the signal strength of a radio station is less than the predefined threshold value, the radio station may be determined to be non-potential radio station for the user. If the signal strength of a radio station is greater than the predefined threshold value, the radio station may be determined to be one of the one or more potential radio stations. In an embodiment, information associated with the one or more potential radio stations may be stored as the radio station data 208 in the memory 108.

Upon identifying the one or more potential radio stations, the radio station selection module 202 may be configured to select the at least one radio station from the one or more potential radio stations. The radio station selection module 202 may be configured to fetch or receive the metadata of each of the one or more potential radio stations from the radio station server 104. In an embodiment, the radio station selection module 202 may receive the metadata, in real-time. In an embodiment, the radio station selection module 202 may receive the metadata of all the plurality of radio stations and pre-store them in the memory 108. In such case, the metadata of the one or more potential radio stations may only be identified and used for selecting the at least one radio station. Using the received metadata for the one or more potential radio stations, the radio station selection module 202 may implement a machine learning approach to identify the at least one radio station for the user. The radio station selection module 202 considers the at least one preference 206 of the user and correlates the at least one preference 206 with the received metadata. By such correlation, a radio station which falls into a category similar to the at least one preference 206 of the user may be selected to be the at least one radio station for the user. By the proposed method for selecting the radio station, along with radio station that may be frequently listened by the user, other new radio stations, which may be in accordance with preferences of the user or similar to that of preferred radio station, may also be selected.

In an embodiment, the radio station selection module 202 may implement a content-based recommendation model on metadata information to find the similarity between the one or more potential stations and the at least one preference 206. The at least one radio station is selected to be associated with highest similarity percentage. In an embodiment, the radio station selection module 202 may be configured to decide what kind of metadata is to be fetched for the one or more potential radio stations, based on how complicated a list of the one or more potential radio stations is. In an embodiment, kind of the metadata may also be selected depending on how many number of preferences determined for the user.

Consider a scenario where the user travels to other region where frequency (including alternative frequencies) of preferred radio station does not exist. For example, a user who lives in Seattle listens to a preferred radio stations, drives to Vancouver where there is no alternative frequency for the preferred radio station. The user may not be aware of local radio stations of Vancouver. The radio station selection module 202 learns preferences of the radio stations the user listens to and suggests new radio station that is available at Vancouver that is similar to the preferred radio station of the user.

In an embodiment, the radio station selection module 202 may implement a demographic recommendation model that uses collaborative filtering based on profiles of the plurality of users. The information stored in the user repository 102 may be used by the radio station selection module 202 to generate user similarity metric and content similarity metric. The user similarity metric may indicate similarity between any two users from the plurality of users. The content similarity metric may indicate similarity between contents of any two radio stations from the plurality of radio stations. The radio station selection module 202 may include a collaborative filtering technique which computes the user similarity metric and the content similarity metric similarity metrics simultaneously to find the highest similarity clustering. Upon computing the user similarity metric and the content similarity metric, the radio station selection module 202 may be configured to find users with similar features, measure the differences that the user prefer, find radio stations with the highest similarity, and return recommended station lists that are preferred by similar users.

By proposed technique of selecting the at least one radio station, the need to know what region users are from, what age group they are in and so on, may be eliminated. Similar user data is targeted rather than using multiple variables to classify and cluster the users.

In an embodiment, the radio station selection module 202 may be configured to track loss of signal of previously selected radio station. When such a loss is identified, the radio station selection module 202 may be configured to perform re-selection of the at least one radio station for the user. The re-selection may also be performed using steps indicted previously.

Upon selecting the at least one radio station, the user assistance module 203 may be configured to assist the user with the at least one radio station in the vehicle. The selected at least one radio station and information associated with the at least one radio station may be stored as the assistance data 209 in the memory 108. In an embodiment, as shown in FIG. 3f, the user assistance module 203 may be in communication with the infotainment system 103c, for providing assistance to the user. In an embodiment, the user assistance module 203 may be configured to control and auto-tune the infotainment system 103c to the at least one radio station, for automated services. In an embodiment, the user assistance module 203 may merely recommend the at least one radio station to the user. In an embodiment, the assistance may be recommended by displaying the at least one radio station to the user.

In an embodiment, the one or more other modules 205 of the apparatus 101 may be configured to track factors such as the new radio station picked by the user, tuned time duration of new radio station, rating provided by the user for the new radio station and so on, to update the profile of the user.

The other data 210 may store data, including temporary data and temporary files, generated by modules for performing the various functions of the apparatus 101. The one or more modules 109 may also include other modules 205 to perform various miscellaneous functionalities of the apparatus 101. It will be appreciated that such modules may be represented as a single module or a combination of different modules.

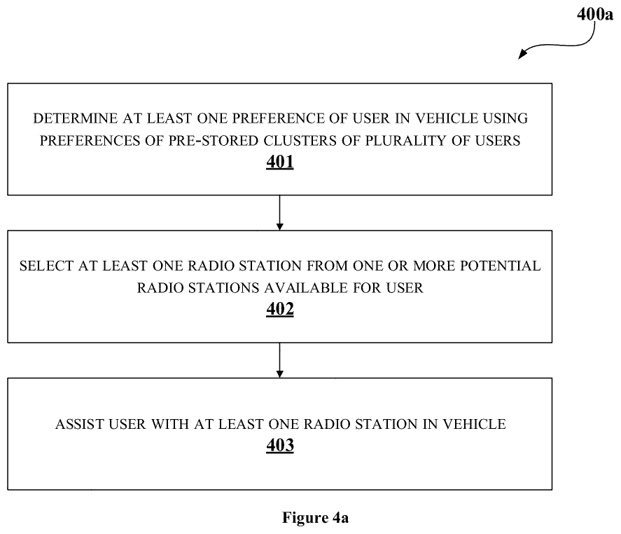

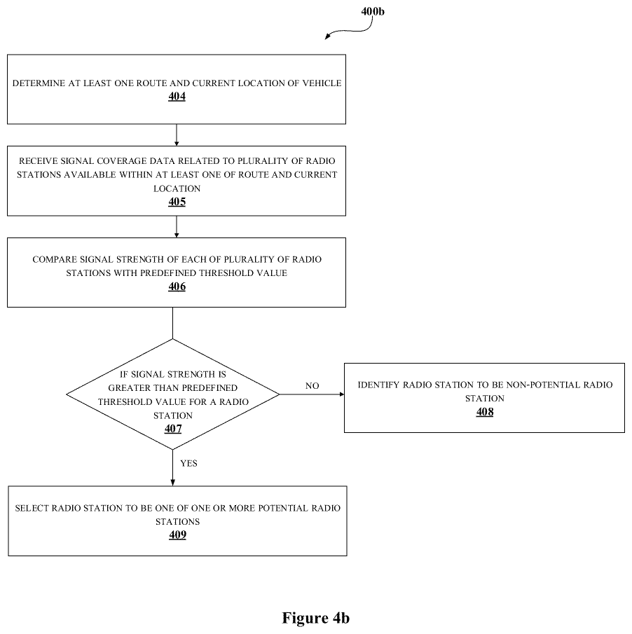

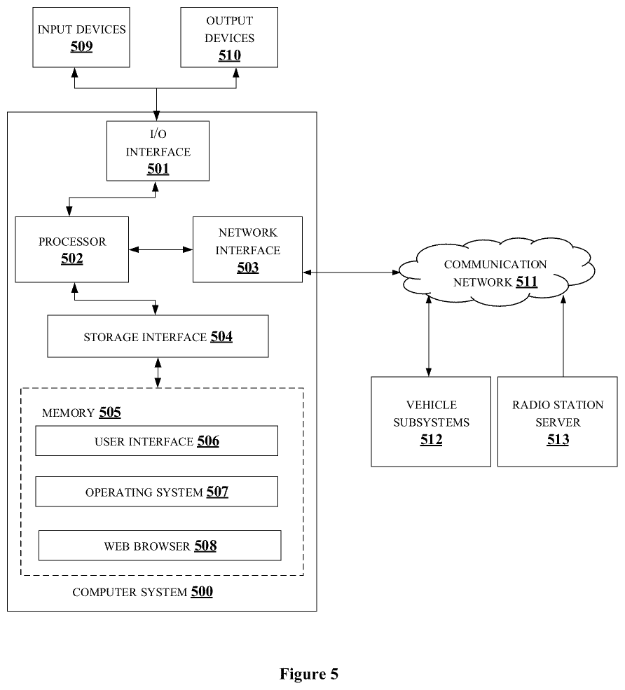

FIG. 4a shows a flow diagram illustrating method for assisting the user in the vehicle with at least one radio station, in accordance with some embodiments of present disclosure.

At block 401, the preference determination module 201 of the apparatus 101 may be configured to determine the at least one preference 206 of the user in the vehicle, using preferences of pre-stored clusters 207 of plurality of users. Each of the pre-stored clusters 207 comprises users with similar preferences related with listening to radio stations. In an embodiment, the pre-stored clusters 207 of the plurality of users may be generated based on at least one of the user information provided by each of the plurality of users and/or the historic data associated with radio stations listened by each of the plurality of users. In an embodiment, the at least one preference 206 of the user may be determined by identifying a cluster from the pre-stored clusters 207 and the cluster is associated with users similar to the user in the vehicle. The similarity between the users in the cluster and the user in the vehicle is based on at least one of user information provided by the users and/or historic data associated with radio stations listened by the users. Further, the at least one preference 206 associated with one or more users in the cluster is determined to be associated with the user in the vehicle.

At block 402, the radio station selection module 202 of the apparatus 101 may be configured to select the at least one radio station from the one or more potential radio stations available for the user, based on the at least one preference 206. For the selection, the radio station selection module 202 may be configured to receive the metadata associated with the one or more potential radio stations and categorize the at least one preference 206 of the user to be related to a metadata associated with at least one radio station from the one or more potential radio stations. Said at least one radio station is selected for the user.

FIG. 4b shows a flow diagram illustrating method for identifying the one or more potential radio stations available for the user, in accordance with some embodiments of present disclosure.

At block 404, the potential radio stations identification module 204 of the apparatus 101 may be configured to determine at least one of a route and a current location of the vehicle. In an embodiment, the route and the current location may be determined using navigation system or GPS system in the vehicle.

At block 405, the potential radio stations identification module 204 of the apparatus 101 may be configured to receive the signal coverage data related to plurality of radio stations available within at least one of the route and the current location of the vehicle.

At block 406, the potential radio stations identification module 204 of the apparatus 101 may be configured to compare the signal strength, derived from corresponding signal coverage data of each of the plurality of radio stations, with the predefined threshold value.

At block 407, the potential radio stations identification module 204 of the apparatus 101 may be configured to check of the signal strength of a radio station from the plurality of radio stations is greater than the predefined threshold value. If the signal strength of the radio station is less than the predefined threshold value, the step in block 408 is performed. If the signal strength of the radio station is greater than the predefined threshold value, the step in block 409 is performed.

At block 408, the potential radio stations identification module 204 of the apparatus 101 may be configured to identify the radio station, whose signal strength is less than the predefined threshold value, to be non-potential radio station for the user.

At block 409, the potential radio stations identification module 204 of the apparatus 101 may be configured to select the radio station, whose signal strength is greater than the predefined threshold value, to be one of the one or more potential radio stations.

Referring back to FIG. 4a, at block 403, upon selecting the at least one radio station, the user assistance module 203 of the apparatus 101 may be configured to assist the user with the at least one radio station in the vehicle. In an embodiment, the assistance may be provided by recommending the at least one radio station to the user using an infotainment system in the vehicle. In an embodiment, the assistance may be provided by auto-tuning the infotainment system in the vehicle to the at least one radio station.

The methods illustrated in FIGS. 4a, and 4b may include one or more blocks for executing processes in the apparatus 101. The methods illustrated in FIGS. 4a, and 4b may be described in the general context of computer executable instructions. Generally, computer executable instructions can include routines, programs, objects, components, data structures, procedures, modules, and functions, which perform particular functions or implement particular abstract data types.

The order in which the methods illustrated in FIGS. 4a, and 4b are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

### Computing System

FIG. 5 illustrates a block diagram of an exemplary computer system 500 for implementing embodiments consistent with the present disclosure. In an embodiment, the computer system 500 is used to implement the apparatus 101. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), radio frequency (RF) antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

In some embodiments, the computer system 500 may consist of the apparatus 101. The processor 502 may be disposed in communication with a communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with vehicle subsystems 512 and radio station server 513, for assisting user with at least one radio station. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web browser 508 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™ GOOGLE® ANDROID™, BLACKBERRY® OS, or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Hypertext Transport Protocol Secure (HTTPS), Secure Sockets Layer (SSL), Transport Layer Security (TLS), etc. Web browser 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft.NET, Common Gateway Interface (CGI) scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc (CD) ROMs, DVDs, flash drives, disks, and any other known physical storage media.

### Advantages

An embodiment of the present disclosure may provision a methodology of finding new user preferred station lists for better user experience. The new preferred station may be found by considering similarity with respect to preferences of other users. By which, even minimal data from the user, accurate prediction of the new preferred station may be achieved.

An embodiment of the present disclosure may use minimum metadata requirement for each station, with use of accurate preferences.

An embodiment of the present disclosure discloses to track previous recommendations, current behavior of the user and change in preferences tracked to enhance the recommendation. Hence, a learning approach is proposed to improve user experience for every ride.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4a, and 4b shows certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-10. (canceled)

11. A method for assisting a user in a vehicle with at least one radio station, the method comprises:
determining, using preferences of pre-stored clusters of a plurality of users, at least one preference of the user in the vehicle, wherein each of the pre-stored clusters comprises users with similar preferences related to listening to radio stations, wherein a pre-stored cluster associated with the user in the vehicle is determined by identifying pre-stored clusters associated with users similar to the user in the vehicle considering information and historic data;
selecting at least one radio station from one or more potential radio stations available for the user, based on the at least one preference; and
assisting the user with the at least one radio station in the vehicle,
wherein the one or more potential radio stations are identified by
determining at least one of a route and a current location of the vehicle;
receiving signal coverage data related to a plurality of radio stations available within the at least one of the route and the current location of the vehicle; and
selecting, based on the signal coverage data, the one or more potential radio stations for the vehicle from the plurality of radio stations.

12. The method of claim 11, wherein the selecting of the one or more potential radio stations comprises:
comparing signal strength, derived from corresponding signal coverage data of each of the plurality of radio stations, with a predefined threshold value; and
selecting the one or more potential radio stations with the signal strength greater than the predefined threshold value.

13. The method of claim 11, wherein the pre-stored clusters of the plurality of users is generated based on at least one of user information provided by each of the plurality of users or historic data associated with radio stations listened by each of the plurality of users.

14. The method of claim 11, wherein the determining of the at least one preference of the user comprises:
identifying a cluster from the pre-stored clusters, wherein the cluster is associated with users similar to the user in the vehicle; and
determining at least one preference associated with one or more users in the cluster to be associated with the user in the vehicle.

15. The method of claim 14, wherein similarity between the users in the cluster and the user in the vehicle is based on at least one of user information provided by the users and historic data associated with radio stations listened by the users.

16. The method of claim 11, wherein the selecting of the at least one radio station comprises:
receiving metadata associated with the one or more potential radio stations; and
categorizing the at least one preference of the user to be related to a metadata associated with at least one radio station from the one or more potential radio stations, wherein the at least one radio station is selected for the user.

17. The method of claim 11, wherein the assisting of the user with the at least one radio station comprises performing at least one of:
identifying, using an infotainment system in the vehicle, the at least one radio station to the user; or
auto-tuning the infotainment system in the vehicle to the at least one radio station or storing the at least one radio station in the memory of the infotainment system.

18. The method of claim 11, further comprising:
monitoring signal strength of the at least one radio station assisted to the user in the vehicle;
performing selection of one or more other radio stations apart from the at least one radio station, based on the at least one preference, when the signal strength of the at least one radio station is lost; and
assisting the user with the one or more other radio stations in the vehicle.

19. An apparatus for assisting a user in a vehicle with at least one radio station, the apparatus comprises:
a processor; and
a memory communicatively coupled to the processor, wherein the memory stores processor-executable instructions, which, on execution, cause the processor to
determine, using preferences of pre-stored clusters of a plurality of users, at least one preference of the user in the vehicle, wherein each of the pre-stored clusters comprises users with similar preferences related to listening to radio stations, wherein a pre-stored cluster associated with the user in the vehicle is determined by identifying pre-stored clusters associated with users similar to the user in the vehicle considering information and historic data;
select at least one radio station from one or more potential radio stations available for the user, based on the at least one preference; and
assist the user with the at least one radio station in the vehicle, wherein the one or more potential radio stations are identified by
determining at least one of a route and a current location of the vehicle;
receiving signal coverage data related to a plurality of radio stations available within the at least one of the route and the current location of the vehicle; and
selecting, based on the signal coverage data, the one or more potential radio stations for the vehicle from the plurality of radio stations.
